(19) United States
(12) Patent Application Publication
(10) Pub. No.: US 2010/0283375 A1
(43) Pub. Date: Nov. 11, 2010

(54) Ozone generator

(75) Inventors: Yuan-Chao Yang, Beijing (CN); Kai-Li Jiang, Beijing (CN); Shou-Shan Fan, Beijing (CN)

Correspondence Address: Altis Law Group, Inc.;ATTN: Steven Reiss, 288 SOUTH MAYO AVENUE, CITY OF INDUSTRY, CA, 91789, US

(73) Assignees: Tsinghua University, Beijing City (CN); HON HAI Precision Industry CO., LTD., Tu-Cheng City (TW)

(21) Appl. No.: 12/590,257

(22) Filed: Nov. 5, 2009

(30) Foreign Application Priority Data
May 8, 2009 (CN) 200910107300.9

(51) Int. Cl. H01J 1/02

(52) U.S. Cl. 313/309; 977/939

(57) ABSTRACT

An ozone generator includes a plurality of needles having a carbon nanotube linear structure. The carbon nanotube linear structure includes at least one carbon nanotube at a free end thereof. The at least one carbon nanotube acts as a discharge end of each needle.

### CROSS-REFERENCE TO RELATED APPLICATIONS

This application claims all benefits accruing under 35 U.S.C. §119 from China Patent Application No. 200910107300.9, filed on May 8, 2009 in the China Intellectual Property Office, the disclosure of which is incorporated herein by reference.

This application is related to copending application entitled, “ELCTRONIC IGNITION DEVICE”, filed **** (Atty. Docket No. US24925).

### BACKGROUND

1. Technical Field

The present disclosure relates to an ozone generator.

2. Description of Related Art

An ozone generator generally includes a first electrode and a second electrode spaced from and facing to the first electrode. A plurality of needles is disposed on the first electrode and faced to the second electrode. Each needle has a discharge end oriented to the second electrode. A plurality of oxygen molecules is injected into a clearance between the needles and the second electrode when the ozone generator is in use. The oxygen molecules is mixed with air to form a gas medium. Each needle has a discharge end with a small diameter. The discharge end produces a plurality of charges thereby forming a strong electrical field thereon, when a voltage difference is formed between the second electrode and the needles. A corona discharge will occur when a strong electrical field difference exists in the clearance. Part of the gas medium adjacent to the discharge end is ionized by the electrical filed thereby forming a corona current. The corona current provides a plurality of free charges. The oxygen molecules can be bombarded by the free charges to produce a plurality of active oxygen atoms. The active oxygen atoms combine with the oxygen molecules thereby producing a plurality of ozone.

The above-described ozone generator indicates that the corona current is a main factor in ozone yield. A strong electrical field is demanded in order to obtain the corona current when the clearance between the needles and the second electrode is a fixed value. Alternatively, the ozone electrical field needs to adopt a discharge end with a small diameter in order to produce the ozone. It is very difficult to produce a metallic discharge end with a diameter smaller than 1 micrometer however, and most discharge ends are merely a metal thread.

What is needed, therefore, is to provide an ozone generator having a discharge end with a relatively smaller diameter, whereby, the ozone generator can have a relatively higher corona current.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic structural view of an embodiment of an ozone generator.

FIG. 2 shows an SEM image of a twisted carbon nanotube wire.

FIG. 3 shows a Scanning Electron Microscope (SEM) image of an untwisted carbon nanotube wire.

FIG. 4 shows an SEM image of broken-end portions of a carbon nanotube wire.

FIG. 5 shows a Transmission Electron Microscope (TEM) image of a broken-end portion of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

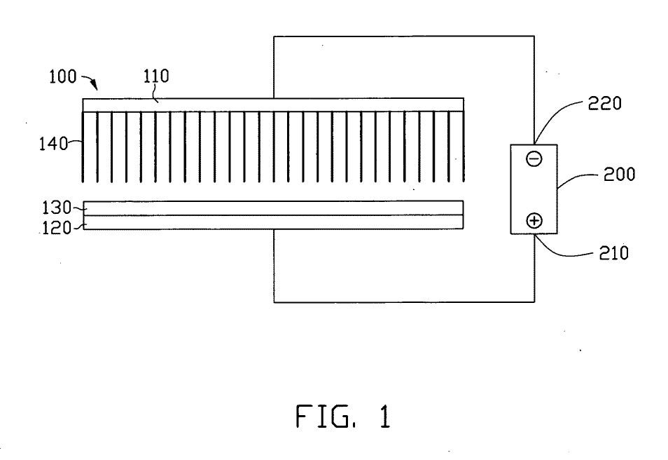

Referring to FIG. 1, an ozone generator 100 includes a first electrode 110, a second electrode 120, a dielectric 130, and a plurality of needles 140. The first electrode 110 and the second electrode 120 are located apart from each other, and are at least partially face to face. The dielectric 130 is disposed on the second electrode 120 and oriented to the first electrode 110. The needles 140 are disposed on the first electrode 110 and oriented to the second electrode 130. The ozone generator 100 can be driven by a power source 200. Oxygen containing gas is passed through a clearance between the needles 140 and the second electrode 120. Oxygen molecules can be mixed with air to form a gas medium.

The power source 200 is configured to provide a working voltage difference between the needles 140 and the second electrode 120. The power source 200 can be a direct current (DC)-power source or an alternative current (AC)-power source. In one embodiment, the power source 200 is a DC-power source. The power source 200 has a positive electrode 210 and a negative electrode 220. The negative electrode 220 is electrically connected to the first electrode 110. The positive electrode 210 is electrically connected to the second electrode 120. Simultaneously, the working voltage difference between the needles 140 and the second electrode 120 has a same value as that of a voltage of the power source 200, such that a corona discharge occurs in the gas medium between the needles 140 and the second electrode 120. The ozone can be produced in the clearance by the corona discharge. Alternatively, the negative electrode 220 can also be electrically connected to the second electrode 110. The positive electrode 210 can also be electrically connected to the first electrode 120.

A shape of the first electrode 110 and the second electrode is not limited. The first electrode 110 and the second electrode 120 can be rod electrodes or flat panel electrodes. In one embodiment, the first electrode 110 and the second electrode 120 are flat panel electrodes. The first electrode 110 is opposite and parallel to the second electrode 120. Alternatively, the first electrode 110 and the second electrodes 120 can also be two concentric hollow cylinder electrodes.

The dielectric 130 and the needles 140 are located apart from each other. The material of the dielectric 130 is not limited. The dielectric 130 can be an insulator made of ceramics, glasses or plastics. In one embodiment, the dielectric 130 is made of ceramics. The dielectric 130 covers a top surface of the second electrode 130. Therefore, the dielectric 130 helps prevent a breakdown from occurring between the second electrodes 120 and the needles 140. When the working voltage difference between is lower than a breakdown voltage, the dielectric 130 can be optional.

The needles 140 are electrically contacted to the first electrode 110. In one embodiment, the needles 140 are fixed on the first electrode 110. The needles 140 can be adhered to the first electrode 110 by a conductive adhesive layer or embedded into the first electrode 110 directly. The needles 140 are located apart from each other. In one embodiment, the needles 140 are parallel to each other thereby shaping an array. The needles 140 include a carbon nanotube linear structure having a diameter of about 0.4 nanometers to about 1 millimeter.

The carbon nanotube linear structure can include a carbon nanotube wire and/or a carbon nanotube cable.

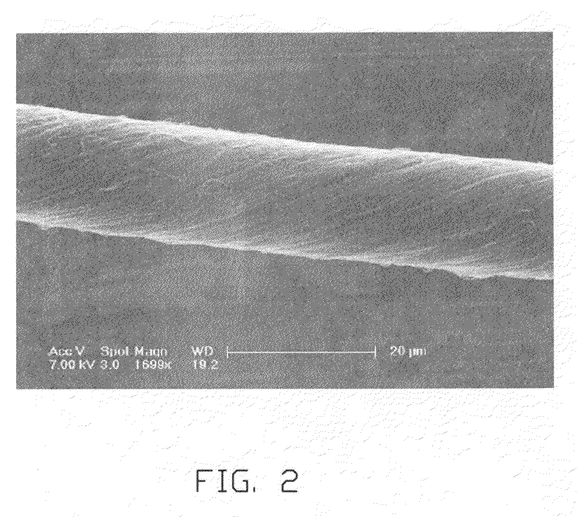

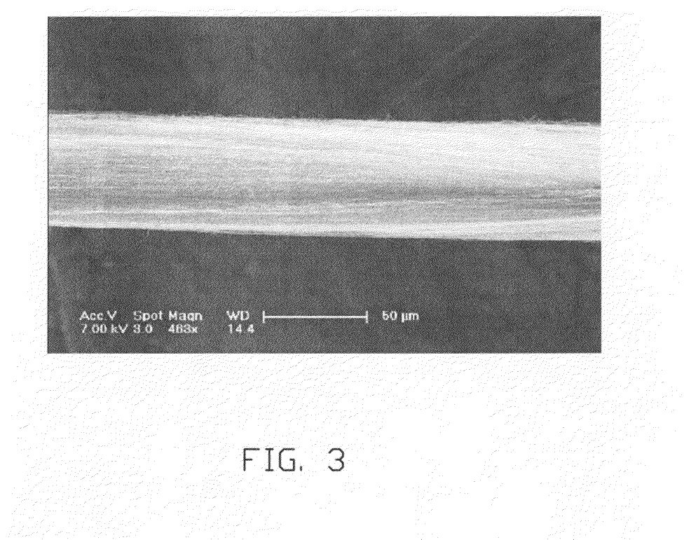

The carbon nanotube wire can be untwisted or twisted. Referring to FIG. 2, the twisted carbon nanotube wire includes a plurality of carbon nanotubes helically oriented around an axial direction of the twisted carbon nanotube wire. More specifically, the twisted carbon nanotube wire includes a plurality of successive carbon nanotube segments joined end to end by van der Waals attractive force therebetween. Each carbon nanotube segment includes a plurality of carbon nanotubes parallel to each other, and combined by van der Waals attractive force therebetween. Length of the carbon nanotube wire can be set as desired. A diameter of the twisted carbon nanotube wire can be from about 0.4 nanometers to about 100 micrometers. Referring to FIG. 3, the untwisted carbon nanotube wire includes a plurality of carbon nanotubes substantially oriented along a same direction (i.e., a direction along the length of the untwisted carbon nanotube wire). The carbon nanotubes are parallel to an axis of the untwisted carbon nanotube wire. More specifically, the untwisted carbon nanotube wire includes a plurality of successive carbon nanotube segments joined end-to-end by van der Waals attractive force therebetween. Each carbon nanotube segment includes a plurality of carbon nanotubes substantially parallel to each other, and combined by van der Waals attractive force therebetween. The carbon nanotube segments can vary in width, thickness, uniformity and shape. Length of the untwisted carbon nanotube wire can be arbitrarily set as desired. A diameter of the untwisted carbon nanotube wire ranges from about 0.4 nanometers to about 100 micrometers.

The carbon nanotube cable includes two or more carbon nanotube wires. The carbon nanotube wires in the carbon nanotube cable can be, twisted or untwisted. In an untwisted carbon nanotube cable, the carbon nanotube wires are parallel with each other. In a twisted carbon nanotube cable, the carbon nanotube wires are twisted with each other.

The carbon nanotube linear structure has a free end. The free end includes at least one carbon nanotube. The carbon nanotube can act as a discharge end of each needle 140 and has a diameter less than 50 nanometers. The free end of the carbon nanotube linear structure can include a plurality of carbon nanotubes combined each other by van der Waals attractive force therebetween. Each of the carbon nanotubes of the carbon nanotube linear structure can act as the discharge end of the needles 140. The discharge end can produce a plurality of charges thereby obtaining a strong electrical field thereon at a relatively lower working voltage difference. The needles 140 can obtain an asymmetry electrical filed therebetween. Simultaneously, the corona discharge in the clearance will occur at a relatively lower working voltage difference, because of the strong electrical field, by using the carbon nanotube linear structure as the needles 140. A relatively higher corona current is easily produced, because the working voltage difference is relatively lower. Thus, the carbon nanotube linear structure can enhance the yield of the ozone.

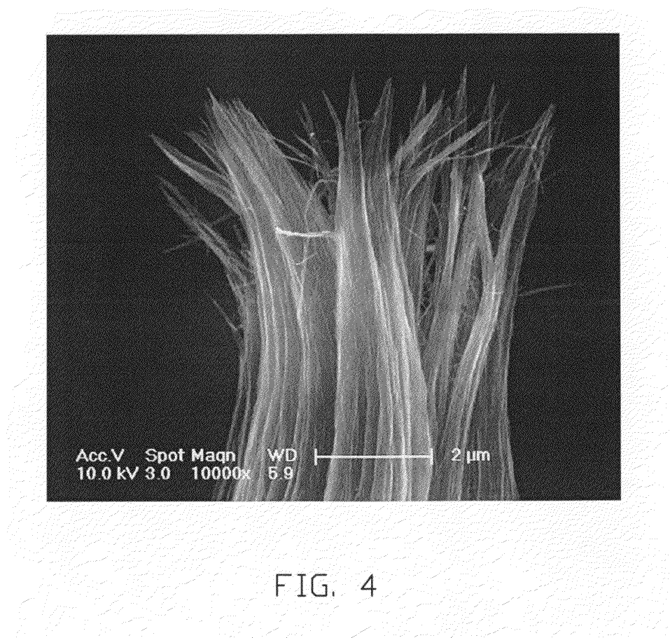

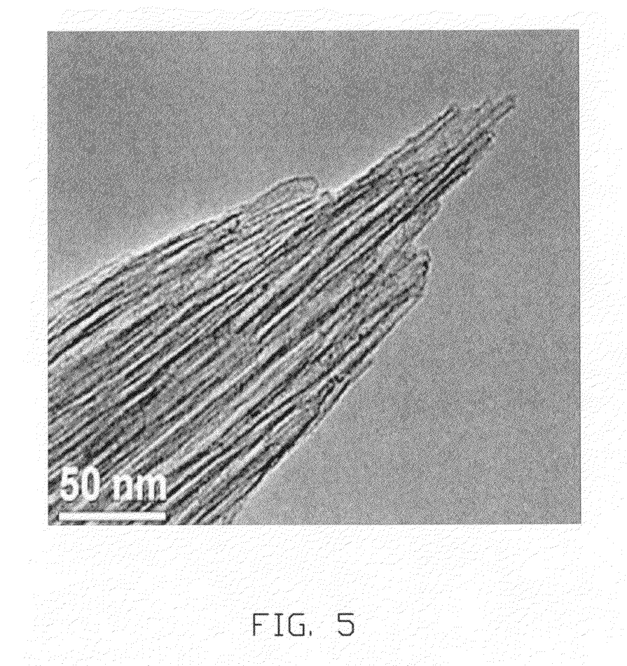

In one embodiment, the carbon nanotube linear structure has a broken-end portion close to the second electrode 120. The broken-end portion can be formed by melting the carbon nanotube linear structure, by ablating the carbon nanotube linear structure with a laser, or by scanning the carbon nanotube linear structure with an electron beam. The broken-end portion includes at least one taper-shaped structure. The at least one carbon nanotube protrudes from the at least one taper-shaped structure. The at least one taper-shaped structure includes a plurality of oriented carbon nanotubes. The at least one carbon nanotube is closer to the second electrode 120 than the other adjacent carbon nanotubes. Moreover, the taper-shaped structure of the at least one taper-shaped structure helps prevent the shield effect caused by the adjacent carbon nanotubes. The carbon nanotubes are parallel to each other, and are combined with each other by van der Waals attractive force. The at least one carbon nanotube can bear relatively higher working voltage differences since the protruding carbon nanotube is fixed by the adjacent carbon nanotubes by van der Waals attractive force. Referring to FIG. 4, in one embodiment, the broken-end portion includes a plurality of taper-shaped structures. Each of the taper-shaped structures includes a plurality of oriented carbon nanotubes. The carbon nanotubes are parallel to each other, and are combined with each other by van der Waals attractive force. The at least one carbon nanotube protrudes from the parallel carbon nanotubes in each taper-shaped structure. Referring to FIG. 5, in one embodiment, the at least one carbon nanotube includes a plurality of carbon nanotubes, and one of the carbon nanotubes protrudes from each taper-shaped structure. Additionally, there can be a gap between tops of the two adjacent taper-shaped structures. That helps prevent the shield effect caused by the adjacent taper-shaped structures.

Alternatively, the surface of the carbon nanotube linear structure can also be coated with a metallic carbide layer or have a plurality of metallic carbide particles thereon. In one embodiment, each of the carbon nanotubes in the carbon nanotube linear structure is coated with the metallic carbide layer or a plurality of metallic carbide particles. The metallic carbide layer or metallic carbide particles have an extremely high melting point, relatively low work function, chemical inertness, and is resistive to ion bombardment. Thus, the metallic carbide layer or metallic carbide particles help prevent the carbon nanotubes from being impacted by ion, and can prolong a lifespan of the carbon nanotube linear structure. The metallic carbide can be hafnium carbide (HfC), zirconium carbide (ZrC), titanium carbide (TiC), columbium carbide (NbC), or combinations thereof. In one embodiment, the metallic carbide is HfC. The method for disposing the metallic carbide layer onto the carbon nanotube linear can include: forming a metal layer coating on the at least one carbon nanotube of the carbon nanotube linear structure; melting the metal layer coating by electrifying the carbon nanotube structure in a vacuum, thereby achieving a plurality of metallic carbide particles formed on the carbon nanotube due to a chemical reaction between the carbon atoms in the carbon nanotube and the melted metal layer.

The power source 200 applies the working voltage difference between the needles 140 and the second electrode 120 when the ozone generator 100 is in operation. The discharge end assembles a plurality of charges thereby obtaining the asymmetry electrical field therearound. The gas medium is ionized by the asymmetry electrical field. The corona current is produced in the clearance by the ionized gas medium. A plurality of free charges is employed by the corona. Oxygen molecules mixed in the gas medium is bombarded by the free charges thereby producing a plurality of active oxygen atoms. The ozone is produced by combining the oxygen molecules and the active oxygen atoms. The higher the discharge current, the more the free charges, and the higher the yield of the ozone.

Finally, it is to be understood that the above-described embodiments are intended to illustrate rather than limit the disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

1. An ozone generator, comprising:
a first electrode;
a second electrode;
a plurality of needles being disposed on and electrically connected to the first electrode and oriented toward the second electrode, each of the needles comprising a carbon nanotube linear structure;
wherein the carbon nanotube linear structure comprises at least one carbon nanotube extending from an end thereof.

2. The ozone generator of claim 1, wherein the needles and the second electrode are capable of creating ozone in a gas medium located therebetween, wherein the gas medium comprises of oxygen.

3. The ozone generator of claim 1, wherein the carbon nanotube linear structure has a diameter of about 0.4 nanometers to about 1 millimeter.

4. The ozone generator of claim 1, wherein the carbon nanotube linear structure comprises at least one carbon nanotube wire, the at least one carbon nanotube wire comprises a plurality of successive carbon nanotube segments joined end-to-end by van der Waals attractive force therebetween, each of the carbon nanotube segments comprises a plurality of carbon nanotubes parallel to each other, and combined by van der Waals attractive force therebetween.

5. The ozone generator of claim 4, wherein the at least one carbon nanotube wire comprises the plurality of carbon nanotubes substantially oriented along a same direction, the carbon nanotubes are substantially parallel to an axis of the at least one carbon nanotube wire.

6. The ozone generator of claim 4, wherein the at least one carbon nanotube wire comprises the plurality of carbon nanotubes helically oriented around an axial direction of the carbon nanotube wire.

7. The ozone generator of claim 4, wherein the carbon nanotube linear structure comprises two or more carbon nanotube wires, the carbon nanotube wires are parallel with each other.

8. The ozone generator of claim 4, wherein the carbon nanotube linear structure comprises two or more carbon nanotube wires, the carbon nanotube wires are twisted with each other.

9. The ozone generator of claim 4, wherein a diameter of the carbon nanotube wire ranges from about 0.4 nanometers to about 100 micrometers.

10. The ozone generator of claim 4, wherein a diameter of each carbon nanotube ranges from about 0.4 nanometers to about 100 nanometers.

11. The ozone generator of claim 1, wherein the carbon nanotube linear structure comprises a broken-end portion, the broken-end portion comprises at least one taper-shaped structure, the at least one carbon nanotube protrudes from the at least one taper-shaped structure.

12. The ozone generator of claim 11, wherein the at least one taper-shaped structure comprises a plurality of carbon nanotubes substantially oriented along a same direction, the carbon nanotubes are parallel to each other, and are combined to each other by van der Waals attractive force between, the at least one carbon nanotube protrudes from the plurality of carbon nanotubes in the at least one taper-shaped structure.

13. The ozone generator of claim 12, wherein the at least one carbon nanotube is the only one carbon nanotube that protrudes from the plurality of carbon nanotubes in the at least one taper-shaped structure to form a tip.

14. The ozone generator of claim 1, wherein the carbon nanotube linear structure comprises of metallic carbide

15. The ozone generator of claim 1, wherein a plurality of metallic carbide particles are located on the carbon nanotube linear structure.

16. The ozone generator of claim 1, wherein a dielectric is disposed between the second electrode and the first electrode, the dielectric is spaced apart from and opposite to the needles.

17. The ozone generator of claim 1, wherein the first electrode and the second electrode are flat panels parallel to each other.

18. An ozone generator, comprising:
a first electrode;
a second electrode;
a plurality of needles being disposed on and electrically connected to the first electrode and oriented toward the second electrode, each of the needles comprising a carbon nanotube linear structure having a discharge end, the discharge end comprising a plurality of carbon nanotubes, wherein a diameter of the carbon nanotube ranges from about 0.4 nanometers to about 100 nanometers;
wherein the carbon nanotube linear structure comprises at least one carbon nanotube extending from an end thereof.

19. The ozone generator of claim 18, wherein the at least one carbon nanotube protrudes from the plurality carbon nanotubes at the discharge end.

20. The ozone generator of claim 18, wherein each needle has a tapered configuration.
